(19) United States
(12) Patent Application Publication
(10) Pub. No.: US 2012/0301142 A1
(43) Pub. Date: Nov. 29, 2012

(54) Optical Superchannel Method and System

(75) Inventors: Yue-Kai Huang, Princeton, NJ (US); Ting Wang, West Windsor, NJ (US); Philip Nan Ji, Plainsboro, NJ (US); Ezra Ip, Plainsboro, NJ (US)

(73) Assignee: NEC LABORATORIES AMERICA, INC., Priceton, NJ (US)

(21) Appl. No.: 13/479,748

(22) Filed: May 24, 2012

Related U.S. Application Data
(60) Provisional application No. 61/489,509, filed on May 24, 2011.

(51) Int. Cl. H04B 10/06; H04J 14/00; H04Q 11/02

(52) U.S. Cl. 398/48; 398/76

(57) ABSTRACT

Optical superchannel methods and systems that couple two or more local oscillators into a single coherent receiver front end to receive multiple optical subcarriers are shown and described. With multiple local oscillators coupled into a single coherent receiver and appropriate optical selective filtering of the superchannel signal, non-neighboring subcarriers may be received by the single coherent optical receiver.

### CROSS REFERENCE TO RELATED APPLICATION

This application claims the benefit of United States Provisional Patent Application Ser. No. 61/489,509 filed May 24, 2011 which is incorporated by reference as if set forth at length herein.

### TECHNICAL FIELD

This disclosure relates generally to the field of telecommunications and in particular to methods and apparatus' for dynamic intra-channel receiving of optical telecommunication signals.

### BACKGROUND

Optical superchannel is an emerging technology that supports optical transport data rates in excess of 100-Gb/s by combining multiple optical subcarriers to create a composite optical signal exhibiting a desired capacity. Advantageously, optical superchannel technology may allow network operators to realize improved spectral efficiency, greater node-switching flexibility, and lower costs.

### SUMMARY

An advance in the art is made according to an aspect of the present disclosure directed to methods and apparatus for receiving optical superchannels. In sharp contrast to the prior art which employ a number of large bandwidth front-end coherent receivers that each receive neighboring optical subcarriers of an optical superchannel, the methods and apparatus of the present disclosure receive multiple, non-neighboring optical subcarriers of an optical superchannel at a single optical receiver at the same time. Such methods according to the present disclosure we call dynamic intra-channel receiving.

Advantageously, while optical superchannel methods and apparatus according to the present disclosure may only require a single optical receiver to receive non-neighboring optical subcarriers, prior art methods and apparatus require multiple receivers to receive such non-neighboring subcarriers comprising a received superchannel.

In an exemplary embodiment, multiple local oscillators are provided to a single coherent receiver front-end such that different optical sub-carriers that are spaced apart in frequency are down-converted to a baseband in a single operation. Through the effect of optical signal/local oscillator arrangement by filtering and laser tuning, our method and apparatus advantageously minimize any cross talk from non-dropped channels.

### BRIEF DESCRIPTION OF THE DRAWING

A more complete understanding of the present disclosure may be realized by reference to the accompanying drawings in which:

FIG. 1 is a schematic diagram depicting a prior art implementation for non-neighboring subcarrier reception;

FIG. 2 is a schematic diagram depicting the reception of non-neighboring subcarriers with multiple local oscillators according to an aspect of the present disclosure;

FIG. 3 is a schematic diagram depicting the reception of two non-neighboring subcarriers according to an aspect of the present disclosure; and

FIG. 4 is a schematic diagram depicting the reception of three non-neighboring subcarriers according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function.

The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is initially noted that prior art designs of superchannel systems employ multiple receivers since the optical signal bandwidth of the superchannel is too wide for a single optical receiver. Typically each receiver of these prior art superchannel systems receive a single optical sub-carrier—or multiple sub-carriers if the multiple sub-carriers are adjacent to one another in frequency. Of course, such systems require that the multiple sub-carriers so received “fit” into the receiver bandwidth.

As may be readily appreciated by those skilled in the art, these prior art approaches to superchannel systems present particular problems for network switching nodes since it is not always the case that neighboring subcarriers are dropped at a particular receiving node. Consequently, if desired drop subcarriers are not immediate neighbors to one another in frequency—such prior art superchannel systems are unable to receive the subcarriers simultaneously thereby requiring dedicated, multiple receivers.

Advantageously, superchannel systems according to the present disclosure permit non-neighboring sub-carriers to be received simultaneously by a single receiver—which we have previously noted that we call dynamic intra-channel receiving.

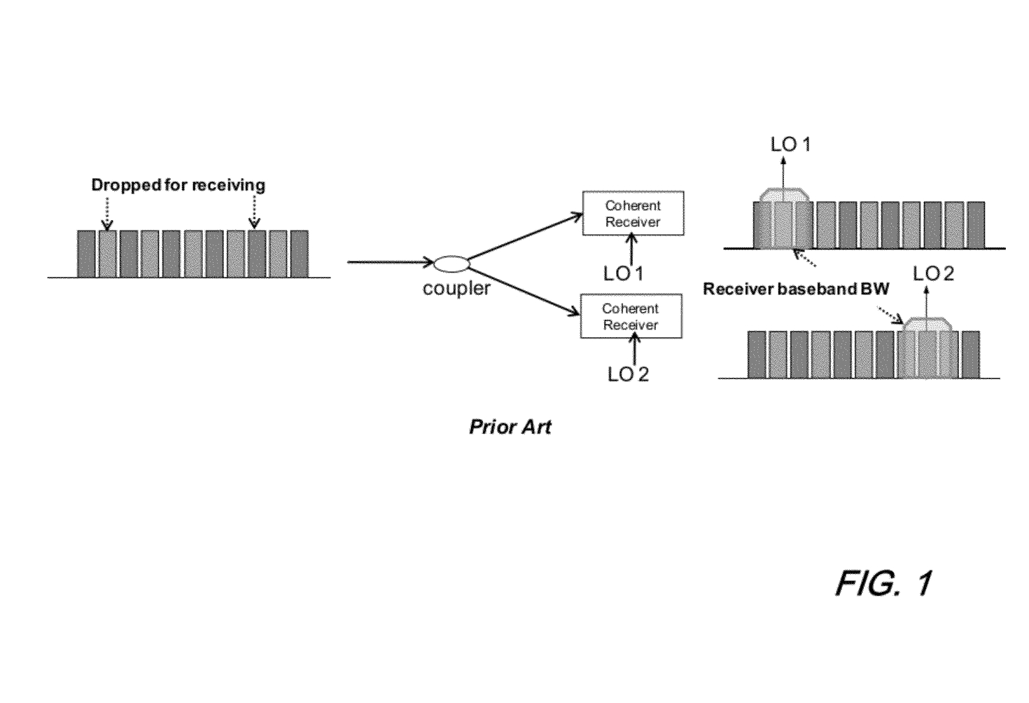

Turning now to FIG. 1, there it shows the prior-art approach for the reception of non-neighboring subcarriers or a superchannel. As shown in that FIG. 1, an 11-subcarrier superchannel signal—formed by for example, Nyquist filtering wherein each subcarrier is filtered by an optical filter having a bandwidth substantially equal to its modulation baud rate—is used as input to a node (not specifically shown) wherein subcarrier #2 and subcarrier #9 are dropped for receiving.

As shown further in FIG. 1 the superchannel is split through the effect of an optical coupler (splitter) and directed to a pair of coherent receivers. As depicted in FIG. 1, each of the coherent receivers exhibits a bandwidth that substantially “covers” two optical subcarriers. As those skilled in the art will readily appreciate, since the two optical subcarriers to be dropped that are depicted in FIG. 1 are spaced too far apart in frequency for a single one of the two coherent receivers to detect both. Consequently, two coherent receivers—each with an individual local oscillator input (LO)—is employed. As depicted further in FIG. 1, one of the coherent receivers employs local oscillator 1 (LO 1) while the second one of the coherent receivers employs local oscillator 2 (LO 2).

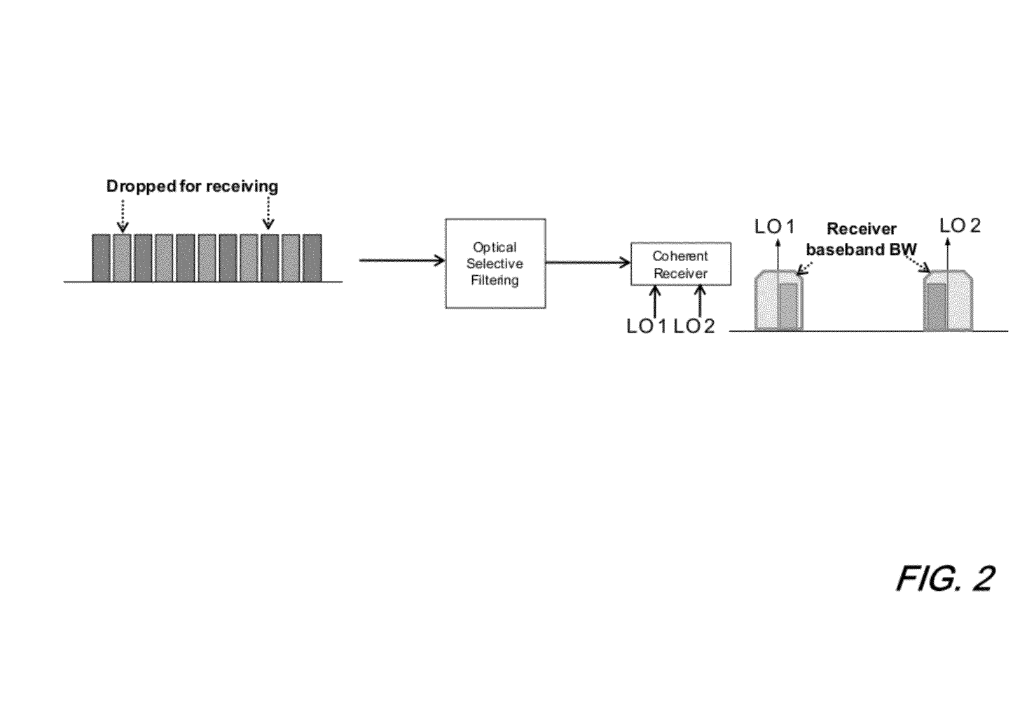

As will now be apparent to those skilled in the art and with reference to FIG. 2, superchannel systems and methods according to the present disclosure overcome the noted disadvantages of the prior art systems and methods. With reference now to that FIG. 2, there it is depicted a superchannel signal like that depicted in FIG. 1 comprising 11 subchannels wherein subchannel #2 and subchannel #9 are designated as dropped for receiving. Unlike the prior art approach depicted in FIG. 1, the method and system according to the present disclosure depicted in FIG. 2 only employs a single coherent receiver.

Accordingly, the superchannel signal is first optically, selectively filtered such that the two subchannels (#2 and #9) are applied to a signal port of the single coherent receiver which has applied to its local oscillator port (LO port) two local oscillator signals, namely LO 1 and LO2. Additionally, the applied LO signals (LO 1 and LO 2) are not centered at the subcarrier frequencies. Instead, the frequencies of the applied LO signals are offset such that down-converted subcarriers do not overlap and therefore create interference in baseband. As an illustrative example—and as depicted in

FIG. 2, LO 1 is tuned to the left of subcarrier #2 and LO 2 is tuned to the right of subcarrier #9 such that subcarrier #2 occupies the positive side of baseband and subcarrier #9 occupies the negative side of baseband.

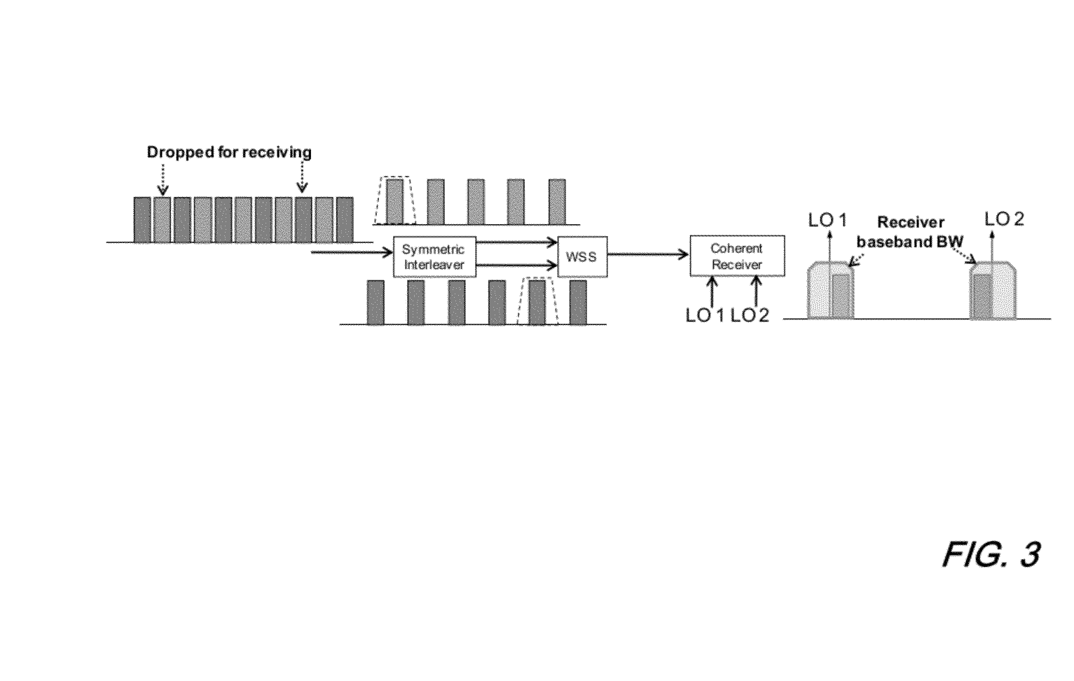

Turning now to FIG. 3, there is shown an additional example of two non-neighboring subcarrier receiving according to another aspect of the present disclosure. More specifically, FIG. 3 depicts an example of how the optical selective filtering for dynamic intra-channel receiving may be implemented by cascading a symmetric optical interleaver and a wavelength selective switch (WSS).

As depicted in FIG. 3, an 11-subcarrier superchannel signal—formed by for example, Nyquist filtering wherein each subcarrier is filtered by an optical filter having a bandwidth substantially equal to its modulation baud rate—is used as input to a node (not specifically shown) wherein subcarrier #2 and subcarrier #9 are dropped for receiving. In this example, the optical interleaver has its filter spacing matched to the subcarrier spacing of the Nyquist filtering superchannel such that immediately neighboring subchannels may be separated.

As depicted, the symmetric optical interleaver has a single input to which is applied the superchannel signal and two outputs which are further connected to two inputs of a wavelength selective switch. The two outputs of the interleaver contain the “odd” and “even” groups of the superchannel which are applied to a respective input of the wavelengfth selective switch (WSS).

The WSS, upon receiving the odd and even groups of the superchannel signal output by the symmetric interleaver will pick or otherwise separate out the two subcarriers needed for receiving. These two subcarriers are then applied to a single coherent receiver which includes two local oscillators (LO 1, LO 2) applied as described previously. Advantageously, a sharp filtering edge of the optical interleaver insures that interference from immediate neighboring subcarriers—in this instance subcarrier #1 and subcarrier #10—is reduced or minimized. As before, the LO frequency(ies) are not coincident with the centers of the subcarrier frequencies rather they are offset. More particularly, and as depicted in FIG. 3, the LO 1 is tuned to the left of the subcarrier while LO 1 is tuned to the right.

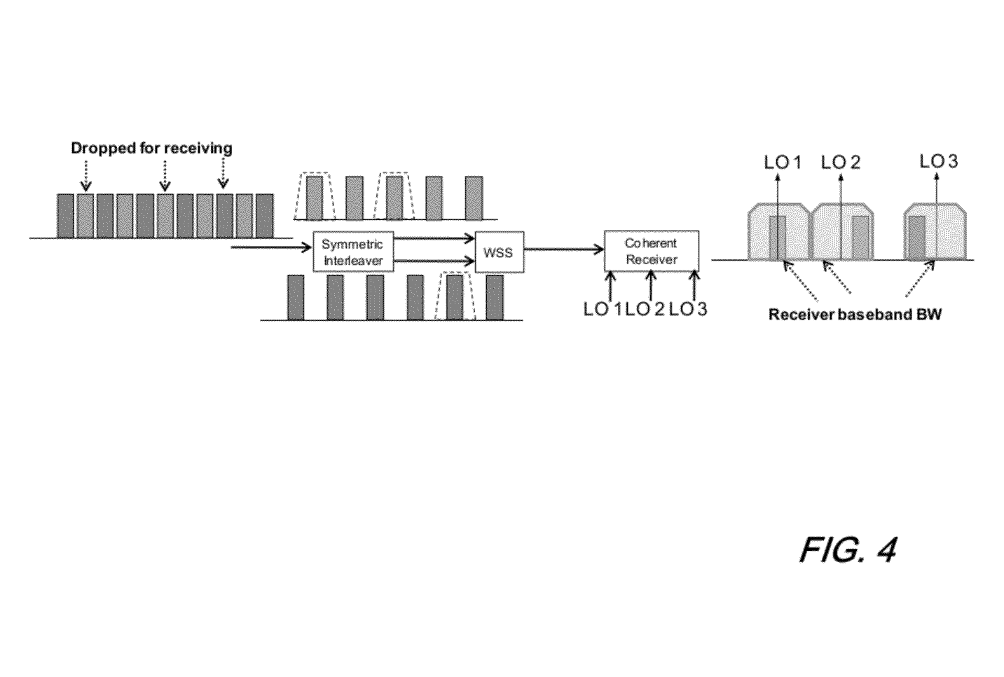

Notably, and with reference now to FIG. 4, there is shown an example configuration according to the present disclosure for the reception of three non-neighboring subcarriers. In this example depicted in FIG. 4 an 11-subcarrier superchannel signal—formed by for example, Nyquist filtering wherein each subcarrier is filtered by an optical filter having a bandwidth substantially equal to its modulation baud rate—is used as input to a node (not specifically shown) wherein subcarrier #2, subcarrier #5 and subcarrier #9 are dropped for receiving.

As depicted in this example, the superchannel signal is applied to an input of a symmetric interleaver the output of which is directed to the inputs of a wavelength selective switch. The wavelength selective switch selects the three subcarriers to be dropped and applies those signals to a single coherent receiver having a single input and three distinct local oscillators namely, LO 1, LO 2, and LO 3.

As depicted in this example shown in FIG. 4, the local oscillators (LO 2 and LO 3) are tuned to the left of subcarrier #5 and to the right of subcarrier #9 respectively. Local oscillator, LO 1 is shown as centered about subcarrier #2.

While this disclosure has been shown and described using particular examples, those skilled in the art will readily appreciate that the disclosure contemplates application beyond the illustrative examples shown. Accordingly, the disclosure should be viewed as limited only by the scope of the claims that follow.

1. A method of receiving multiple subcarriers of an optical superchannel signal comprising the steps of:
applying the optical superchannel signal to an optical interleaver/deinterleaver such that even and odd output signals are produced;
applying the even and odd signals to a wavelength selective switch such that desired subcarriers of the optical superchannel are output as an output signal; and
applying the output signal of the wavelength selective switch to a single coherent optical receiver having multiple local oscillators, one for each of the subcarriers received, such that the multiple subcarriers are received.

2. The method of claim 1 wherein the local oscillators exhibit frequencies that are offset such that the received subcarriers do not overlap.

3. The method of claim 2 wherein the local oscillators exhibit frequencies that are not substantially centered at the frequencies of the subcarriers.

4. The method of claim 3 wherein the coherent receiver exhibits a bandwidth that is wider than that of a single subcarrier.

5. The method of claim 3 wherein the spacing of the interleaver/deinterleaver substantially matches the frequency spacing of the subcarriers.

6. A method of receiving multiple subcarriers of an optical superchannel signal comprising the steps of:
selectively optically filtering the optical superchannel signal such that desired multiple subcarriers are output;
applying distinct, multiple local oscillators, one for each of the desired multiple subcarriers to a single coherent receiver; and
applying the output multiple subcarriers to the single coherent optical receiver such that each of the subcarriers is received;
wherein the local oscillators exhibit frequencies that are not substantially centered at the frequencies of the subcarriers and are offset such that the received subcarriers do not overlap.

7. The method of claim 6 wherein the coherent receiver exhibits a bandwidth that is wider than that of a single subcarrier.

8. The method of claim 6 wherein the selective optical filtering step comprises the step of optically de-interleaving such that even and odd output signals are produced.

9. The method of claim 8 wherein the selective optical filtering step comprises the step of switching the even and odd signals through the effect of a wavelength selective switch such that desired subcarriers of the optical superchannel are output as an output signal.
